(19) United States
(12) Patent Application Publication
(10) Pub. No.: US 2026/0008883 A1
(43) Pub. Date: Jan. 8, 2026

(54) POLYTHIOL COMPOSITION AND OPTICAL RESIN MATERIAL

(71) Applicant: EFIRM NEW MATERIAL CO., LTD., Binzhou (CN)

(72) Inventors: Deyang JIANG, Binzhou (CN); Wangen LIANG, Binzhou (CN); Jianlin ZHANG, Binzhou (CN); Weihua CUI, Binzhou (CN); Hairong ZHENG, Binzhou (CN); Xianjun YI, Binzhou (CN); Feiyu CAO, Binzhou (CN); Jianqing HAN, Binzhou (CN); Bin SONG, Binzhou (CN)

(73) Assignee: EFIRM NEW MATERIAL CO., LTD., Binzhou (CN)

(21) Appl. No.: 19/133,261

(22) PCT Filed: Mar. 28, 2024
(86) PCT No.: PCT/CN2024/084324

§ 371 Date: May 28, 2025

(30) Foreign Application Priority Data
Jun. 30, 2023 (CN) 202310796714.7

(51) Int. Cl. C08G 18/38; C08G 18/75; G02B 1/04

(52) U.S. Cl. CPC C08G 18/3876; C08G 18/758; G02B 1/041

(57) ABSTRACT

A polythiol composition and an optical resin material are provided. The polythiol composition includes tetrakis(3-mercaptopropionate)pentaerythritol and tetrakis(3-amercaptopropionate)pentaerythritol disulfide substitute, and the mass ratio of the tetrakis(3-mercaptopropionate)pentaerythritol disulfide substitute to tetrakis(3-mercaptopropionate)pentaerythritol is 1:(181-10000). By controlling the tetrakis(3-mercaptopropionate)pentaerythritol disulfide substitute in a specific proportion in the polythiol composition in the present invention, the phenomenon of gel polymerization inhibition can be effectively avoided, and presence of active groups in resin lenses and the permeation of water and oxygen are reduced, thereby greatly reducing the aging process of the resin lenses.

### CROSS REFERENCE TO THE RELATED APPLICATIONS

This application is the national phase entry of International Application No. PCT/CN2024/084324, filed on Mar. 28, 2024, which is based upon and claims priority to Chinese Patent Application No. 202310796714.7, filed on Jun. 30, 2023, the entire contents of which are incorporated herein by reference.

### TECHNICAL FIELD

The invention relates to the technical field of optical materials, and specifically to a polythiol composition and an optical resin material.

### BACKGROUND

With the rapid development of the information society, the myopia rate is increasing year by year, and the onset age is gradually becoming lower in age. According to relevant statistics, myopia rate is 14.3% for the 6-year-old children, 35.6% for the pupils, 71.7% for the junior middle school students and 80.5% for the senior middle school students. Reasonable wearing of glasses and timely correction of vision can avoid further decline in vision caused by the fatigue of lens of eyes.

The polythiol compound is used for the lens monomer with a refractive index of 1.56-1.61, and the prepared lens has excellent advantages in refractive index, toughness, light transmittance characteristics and cost, occupying more market shares. At present, the curing process of the lens includes the following steps: evenly mixing reaction materials, pouring the mixture into a mold, and putting the mixture into an oven for heating and curing, wherein the reaction rate is accelerated along with the increase of the temperature and the crosslinking degree. However, the reaction is carried out in the oven statically, and the polythiol compound has lower reaction activity and larger steric hindrance. In this case, the self crosslinking of isocyanate groups and gel polymerization inhibition will occur, i.e., after the viscosity of the reaction material is increased or the reaction material is partially solidified, insufficient contact of the active groups results in the presence of uncrosslinked sulfhydryl groups and isocyanate groups during crosslinking, and due to the higher activity of the groups, the phenomenon of aging and yellowing is easy to occur. Besides, the wearing period of glasses is as long as 1 to 2 years, and in the wearing process, light and oxygen can cause active group denaturation, so that the lenses become yellow and their transparency is reduced; Moreover, owing to the ester groups in polythiol compounds, the secretion and permeation of human oils and sweat can damage the molecular chain of lenses, exacerbating the aging rate. The phenomenon is especially obvious on the frameless glasses. Because cutting the edge of the lens will generate heat and the edge is not protected by the film layer, the lens is easy to oxidize and turn yellow, causing the prism effect. Therefore, the generation of visual fatigue is aggravated, and the visual acuity of teenagers is reduced.

### SUMMARY

As for the aforesaid problems, the invention provides a polythiol composition and an optical resin material. By adopting a tetrakis(3-mercaptopropionate)pentaerythritol disulfide substitute in a specific proportion in the polythiol composition, the phenomenon of gel polymerization inhibition can be effectively avoided, and presence of active groups in resin lenses and the permeation of water and oxygen are reduced, thereby greatly reducing the aging and yellowing process of the resin lenses, reducing the occurrence of prism effect and reducing visual fatigue.

The technical solution adopted in the present invention is as follows:

The polythiol composition includes tetrakis(3-mercaptopropionate)pentaerythritol and a tetrakis(3-mercaptopropionate)pentaerythritol disulfide substitute, and a mass ratio of the tetrakis(3-mercaptopropionate)pentaerythritol disulfide substitute to tetrakis(3-mercaptopropionate)pentaerythritol is 1:(181-10000), and the structural formula of the tetrakis(3-mercaptopropionate)pentaerythritol disulfide substitute is shown as Formula 1:

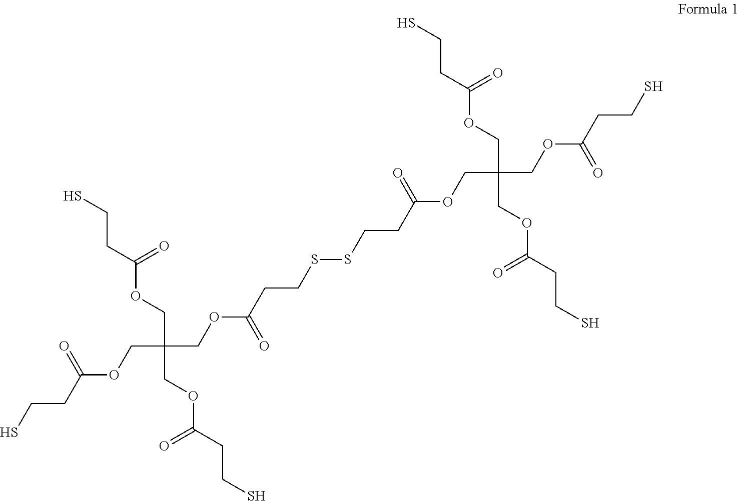 [SMILES: O=C(CCS)OCC(COC(=O)CCS)(COC(=O)CCS)COC(=O)CCSSCCC(=O)OCC(COC(=O)CCS)(COC(=O)CCS)COC(=O)CCS]

Preferably, the polythiol composition includes 50-90 parts of a mixture of tetrakis(3-mercaptopropionate)pentaerythritol and tetrakis(3-mercaptopropionate)pentaerythritol disulfide substitute, 10-20 parts of tris (3-mercaptopropionate)pentaerythritol, 2-15 parts of [2,2-bis(3-sulfonylpropionyloxymethyl)-3-[3-(3-sulfonylpropionylsulfonyl)propionyloxy]propyl]3-sulfonylpropionate, and 50-145 parts of 2,3-dithio(2-mercapto)-1-propanethiol.

Further preferably, the polythiol composition also includes 1-5 parts of bis(3-mercaptopropionate)pentaerythritol, 0-3 parts of 3-mercaptopropionate pentaerythritol, 0-5 parts of [2-(hydroxymethyl)-2-(3-sulfonylpropionyloxymethyl)-3-[3-(3-sulfonylpropionylsulfonyl)propionyloxy]propyl]3-sulfonylpropionate.

An optical resin material, whereas its raw material includes the above-mentioned polythiol composition and an isocyanate.

When the corresponding optical resin material is produced, an auxiliary agent is added to the raw material to further improve the practicability of the obtained optical material, and the raw material may further include additives such as a catalyst, an ultraviolet absorber, a mold release agent, a blue agent, a red agent, etc.

Preferably, the isocyanate is selected from one or more of m-xylylene diisocyanate, cyclohexane dimethylene diisocyanate, hexamethylene diisocyanate, isophorone diisocyanate and norbornane diisocyanate in any proportion.

Preferably, the optical resin material is obtained by curing the raw material.

Compared with other polythiol compounds, the tetrakis(3-mercaptopropionate)pentaerythritol disulfide substitute (abbreviated as disulfide substitute) contains six sulfhydryls, which can obviously improve the reaction activity of the polythiol compound and isocyanate, reduce the reaction steric hindrance, and can react with the isocyanate to form an active site, activating the sulfhydryls of the polythiol. The activated sulfhydryls further react with the isocyanate, which extends a molecular chain, reduces the steric hindrance effect, enables the polymerization to become a point-line-plane type reaction, namely a homopolymerization reaction, avoiding steric hindrance and gel polymerization inhibition phenomena, increasing the crosslinking density and the uniformity of the resin net, reducing the presence of active groups and the permeation of water and oxygen, greatly reducing the aging process. Meanwhile, the structure of the disulfide substitute is similar to that of the polythiol compound, therefore, the lens obtained after polymerization with the isocyanate still possess excellent refractive index, toughness, light transmittance characteristics. In addition, it is not advisable to add too much disulfide substitute in the polythiol composition to avoid too fast reaction and too high viscosity in the degassing stage, which cannot be poured into the mold. It is also not advisable to add too little, otherwise it will not be effective.

The synthesis method of tetrakis(3-mercaptopropionate)pentaerythritol disulfide substitute shown in Formula 1 will be described, but is not limited to this synthesis method. The specific synthesis method includes the following steps: evenly stirring tetrakis(3-mercaptopropionate)pentaerythritol and toluene in a water bath, introducing an oxidizing reagent, preparing under the catalysis of a neutral/alkaline reagent, removing a solvent, and separating by a chromatography column to obtain a disulfide substitute.

Preferably, a mass ratio of tetrakis(3-mercaptopropionate)pentaerythritol to the toluene is 1:(5-10).

Preferably, the oxidizing agent is selected from one or more of air, oxygen, ozone, sulfur trioxide, hydrogen peroxide, m-chloroperbenzoic acid, perbenzoic acid and I₂ in any proportion, when the gaseous oxidizing agent is used, the reaction rate is slow, the selectivity of the product is high, the reaction speed of the liquid oxidizing agent is high, but the polymer compound is easily generated, and the selectivity is slightly poor; and the gaseous oxidizing agent is further preferred.

Preferably, molar ratio of the oxidizing agent to the tetrakis(3-mercaptopropionate)pentaerythritol is (10-30):1, more preferably (15-20):1. When the amount of the oxidizing agent is small, the generation of the disulfide substitute is too small, when the amount of the oxidizing agent is too large, the phenomenon of excessive crosslinking occurs, and after the solvent is removed, there are a few gelatinous substances.

Preferably, the catalyst used in the reaction process can be selected from one or more of ammonia water, sodium hydroxide, potassium hydroxide, calcium hydroxide, sodium bicarbonate, sodium carbonate, potassium carbonate, sodium dihydrogen phosphate, sodium phosphate, diethylamine, triethylamine, triethylenediamine, bis(2-dimethylaminoethyl)ether, 2,2-dimorpholinodiethylether, dimethylaminoethoxyethanol, N,N-dimethylcyclohexylamine, bis(2-dimethylaminoethyl)ether, N,N,N′,N′-tetramethylalkylenediamine, N,N-dimethylbenzylamine, triethanolamine, DMEA, pyridine and N,N′-dimethylpyridine in any proportion; more preferably, the catalyst is selected from one of ammonia water, triethylamine, and N,N-dimethylcyclohexylamine. A molar ratio of the amount of the catalyst to that of the tetrakis(3-mercaptopropionate)pentaerythritol is (0.005-0.05):1, more preferably, the molar ratio is (0.01-0.03):1, when the amount of the catalyst is too small, the amount of the disulfide substitute is small, when the amount of the catalyst is too large, the phenomenon of excessive crosslinking occurs, and after the solvent is removed, there are a few gelatinous substances.

Preferably, a reaction temperature is 10-60° C., more preferably 20-40° C. If the reaction temperature is low, the substrate conversion rate is too low; whereas, if the reaction temperature is high, the phenomenon of excessive crosslinking occurs, and after the solvent is removed, there are a few gelatinous substances.

Preferably, the column height of the chromatography column is 40-80 cm, the diameter-to-height ratio of the column is (15-20):1, the optimal column height is 60 cm, the water absorbent is anhydrous sodium sulfate, the eluent is petroleum ether and ethyl acetate, with a mass ratio of (3-10):1, and further preferably (5-7):1.

The invention provides the polythiol composition and the optical resin material. By controlling the tetrakis(3-mercaptopropionate)pentaerythritol disulfide substitute in the specific proportion in the polythiol composition in the present invention, the phenomenon of gel polymerization inhibition can be effectively avoided, and presence of active groups in resin lenses and the permeation of water and oxygen are reduced, thereby greatly reducing the aging and yellowing process of the resin lenses, reducing the occurrence of prism effect and reducing visual fatigue.

### BRIEF DESCRIPTION OF THE DRAWINGS

FIG. 1 is a second order mass spectrum of the tetrakis(3-mercaptopropionate)pentaerythritol disulfide substitute;

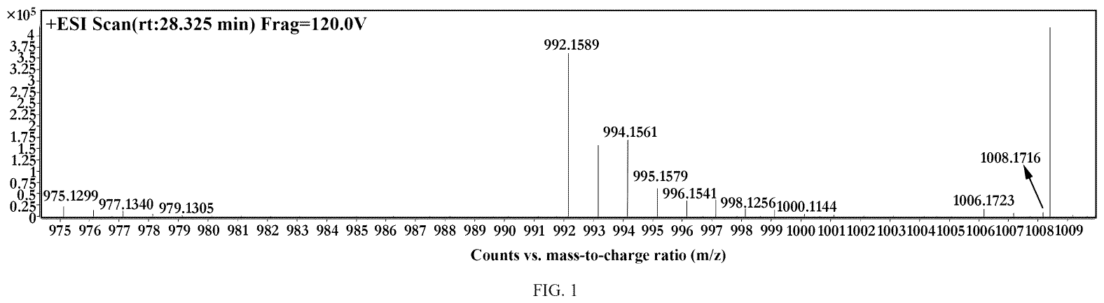

FIG. 2 is an infrared spectrum of the tetrakis(3-mercaptopropionate)pentaerythritol disulfide substitute;

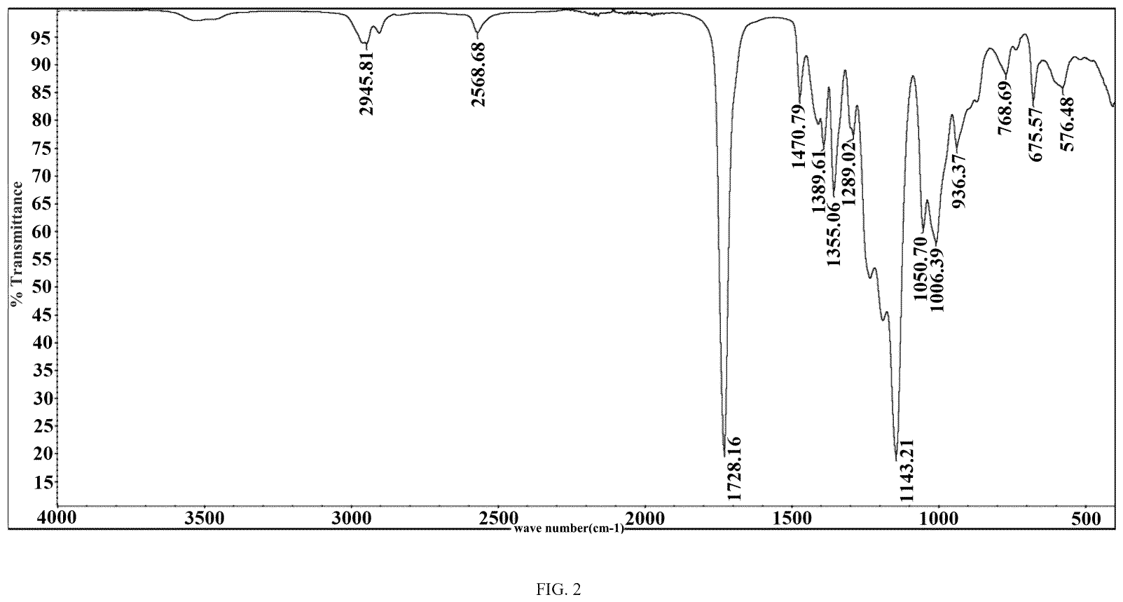

FIG. 3 is a ¹H NMR spectrum of the tetrakis(3-mercaptopropionate)pentaerythritol disulfide substitute.

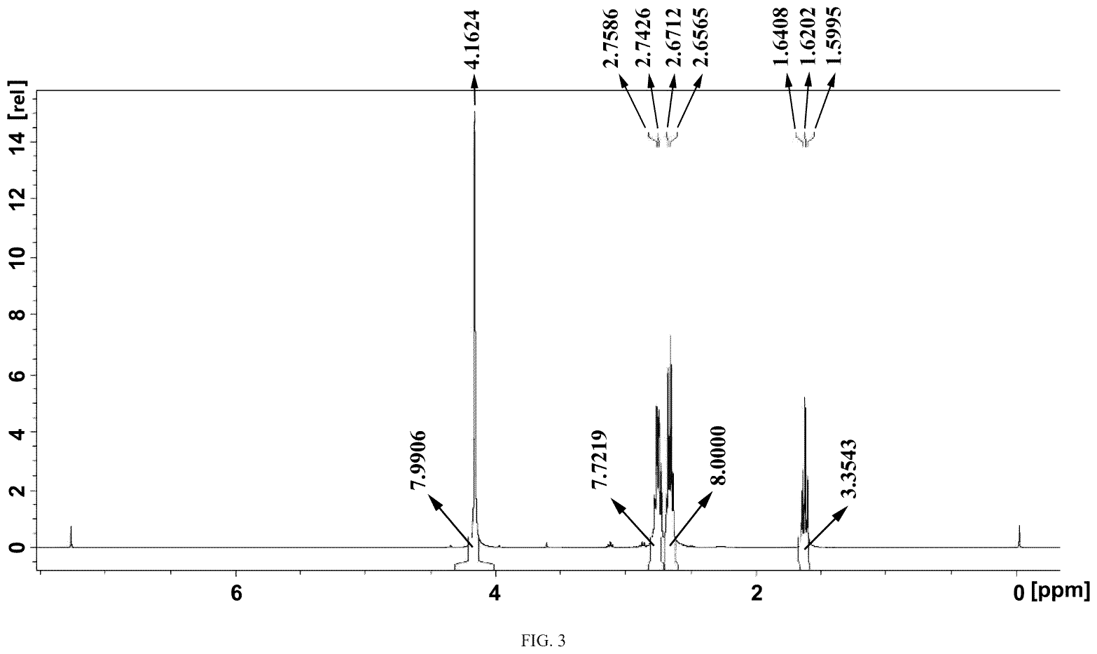

### DETAILED DESCRIPTION OF THE EMBODIMENTS

The description set forth below is intended to provide a further explanation of the present invention with specific embodiments that enable those skilled in the art to further understand the present invention, rather than being a limitation thereof, and those skilled in the art should understand that equivalent substitutions or corresponding improvements to the technical features of the present invention still fall within the protection scope of the present invention.

The light transmittance and yellow value (YI313) were measured using an UltraScan VIS spectrophotometer, manufactured by HunterLab Company, USA, measurements were carried out at 25-30° C., with D65 light source, the spectral range was 360-780 nm.

The following parts are calculated by mass percent.

### Embodiment 1

A synthesis method of the tetrakis(3-mercaptopropionate)pentaerythritol disulfide substitute is as follows:

20 g of tetrakis(3-mercaptopropionate)pentaerythritol and 100 g of toluene were placed in a water bath at 30° C., stirred and dissolved, then 0.13 g of triethylamine was added, 0.82 mol of ozone was slowly introduced into the solution, the reaction was carried out at the temperature of 25° C. for 48 h, and then the toluene was removed in vacuum to obtain bright yellow liquid. A 60 cm-high chromatography column with a diameter-height ratio of 20:1 was used. Anhydrous sodium sulfate was added to the upper layer of silica gel, and the eluent was petroleum ether and ethyl acetate, with a mass ratio of 6:1. The product was obtained through chromatography column separation. 1H NMR (400 MHz, CDCl₃) δ 4.16 (s, 1H, O—C—H), 2.76-2.74 (m, 1H, S—C—H), 2.67-2.66 (m, 1H, O═C—C—H), 1.60-1.64 (m, 1H, S—H).

The disulfide substitute the following refers to the tetrakis(3-mercaptopropionate)pentaerythritol disulfide substitute, as shown in Formula 1:

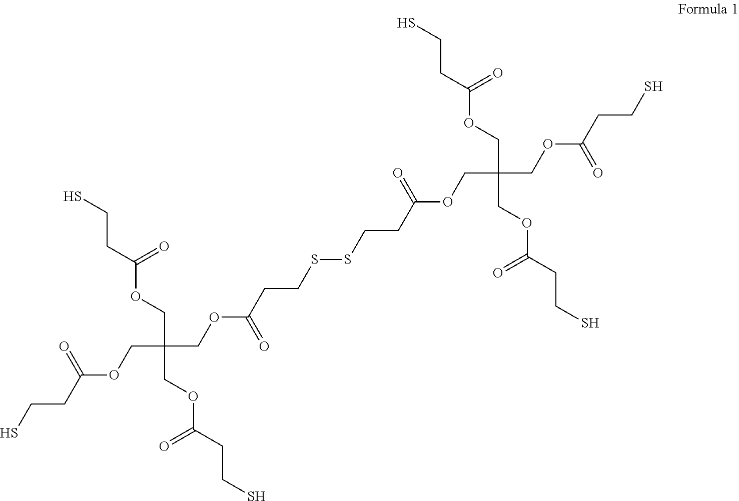 [SMILES: O=C(CCS)OCC(COC(=O)CCS)(COC(=O)CCS)COC(=O)CCSSCCC(=O)OCC(COC(=O)CCS)(COC(=O)CCS)COC(=O)CCS]

### Embodiment 2

### An Optical Resin Material

(1) Polythiol composition: 5.3 g of tris(3-mercaptopropionate)pentaerythritol, 0.02 g of disulfide substitute, 40 g of tetrakis(3-mercaptopropionate)pentaerythritol, 4.5 g of [2,2-bis(3-sulfonylpropionyloxymethyl)-3-[3-(3-sulfonylpropionylsulfonyl)propionyloxy]propyl]3-sulfonylpropionate, 51.9 g of 2,3-dithio(2-mercapto)-1-propanethiol;
(2) 55 parts of norbornane diisocyanate, 45 parts of polythiol composition, 0.05 part of dibutyltin dichloride, 0.6 part of UV absorber 329, and 0.1 part of mold release agent (dibutyl phosphate) were evenly mixed, filtered by a 1 μm filter, and degassed in vacuum at 30° C. for 30 min, and injected into a mold. The temperature was increased from 30° C. to 120° C. in a gradient manner over 8 h, kept at 120° C. for 2 h, and then decreased to 60° C. over 3 h. Then an optical resin material was obtained, after coating, the obtained optical lens was placed at 50° C. and 95% RH for 200 h, and performance test was carried out after accelerated aging verification.

### Embodiment 3

### An Optical Resin Material

(1) Polythiol composition: 5.3 g of tris (3-mercaptopropionate)pentaerythritol, 0.095 g of disulfide substitute, 40 g of tetrakis(3-mercaptopropionate)pentaerythritol, 4.5 g of [2,2-bis(3-sulfonylpropionyloxymethyl)-3-[3-(3-sulfonylpropionylsulfonyl)propionyloxy]propyl]3-sulfonylpropionate, 51.9 g of 2,3-dithio(2-mercapto)-1-propanethiol;
(2) 55 parts of norbornane diisocyanate, 45 parts of polythiol composition, 0.05 part of dibutyltin dichloride, 0.6 part of UV absorber 329, and 0.1 part of mold release agent (dibutyl phosphate) were evenly mixed, filtered by a 1 pm filter, and degassed in vacuum at 30° C. for 30 min, and injected into a mold. The temperature was increased from 30° C. to 120° C. in a gradient manner over 8 h, kept at 120° C. for 2 h, and then decreased to 60° C. over 3 h. Then an optical resin material was obtained, after coating, the obtained optical lens was placed at 50° C. and 95% RH for 200 h, and performance test was carried out after accelerated aging verification.

### Embodiment 4

### An Optical Resin Material

(1) Polythiol composition: 5.3 g of tris (3-mercaptopropionate)pentaerythritol, 0.15 g of disulfide substitute, 40 g of tetrakis(3-mercaptopropionate)pentaerythritol, 4.5 g of [2,2-bis(3-sulfonylpropionyloxymethyl)-3-[3-(3-sulfonylpropionylsulfonyl)propionyloxy]propyl]3-sulfonylpropionate, 51.9 g of 2,3-dithio(2-mercapto)-1-propanethiol;
(2) 55 parts of norbornane diisocyanate, 45 parts of polythiol composition, 0.05 part of dibutyltin dichloride, 0.6 part of UV absorber 329, and 0.1 part of mold release agent (dibutyl phosphate) were evenly mixed, filtered by a 1 um filter, and degassed in vacuum at 30° C. for 30 min, and injected into a mold. The temperature was increased from 30° C. to 120° C. in a gradient manner over 8 h, kept at 120° C. for 2 h, and then decreased to 60° C. over 3 h. Then an optical resin material was obtained, after coating, the obtained optical lens was placed at 50° C. and 95% RH for 200 h, and performance test was carried out after accelerated aging verification.

### Embodiment 5

### An Optical Resin Material

(1) Polythiol composition: 5.3 g of tris(3-mercaptopropionate)pentaerythritol, 0.216 g of disulfide substitute, 40 g of tetrakis(3-mercaptopropionate)pentaerythritol, 4.5 g of [2,2-bis(3-sulfonylpropionyloxymethyl)-3-[3-(3-sulfonylpropionylsulfonyl)propionyloxy]propyl]3-sulfonylpropionate, 51.9 g of 2,3-dithio(2-mercapto)-1-propanethiol;
(2) 55 parts of norbomane diisocyanate, 45 parts of polythiol composition, 0.05 part of dibutyltin dichloride, 0.6 part of UV absorber 329, and 0.1 part of mold release agent (dibutyl phosphate) were evenly mixed, filtered by a 1 μm filter, and degassed in vacuum at 30° C. for 30 min, and injected into a mold. The temperature was increased from 30° C. to 120° C. in a gradient manner over 8 h, kept at 120° C. for 2 h, and then decreased to 60° C. over 3 h. Then an optical resin material was obtained, after coating, the obtained optical lens was placed at 50° C. and 95% RH for 200 h, and performance test was carried out after accelerated aging verification.

### Embodiment 6

### An Optical Resin Material

(1) Polythiol composition: 0.6 g of bis(3-mercaptopropionate)pentaerythritol, 5.3 g of tris(3-mercaptopropionate)pentaerythritol, 0.15 g of disulfide substitute, 1.7 g of 2-(hydroxymethyl)-2-(3-sulfonylpropionyloxymethyl)-3-[3-(3-sulfonylpropionylsulfonyl)propionyloxy]propyl]3-sulfonylpropionate, 40 g of tetrakis(3-mercaptopropionate)pentaerythritol, 4.5 g of [2,2-bis(3-sulfonylpropionyloxymethyl)-3-[3-(3-sulfonylpropionylsulfonyl)propionyloxy]propyl]3-sulfonylpropionate, 51.9 g of 2,3-dithio(2-mercapto)-1-propanethiol;
(2) 55 parts of norbornane diisocyanate, 45 parts of polythiol composition, 0.05 part of dibutyltin dichloride, 0.6 part of UV absorber 329, and 0.1 part of mold release agent (dibutyl phosphate) were evenly mixed, filtered by a 1 μm filter, and degassed in vacuum at 30° C. for 30 min, and injected into a mold. The temperature was increased from 30° C. to 120° C. in a gradient manner over 8 h, kept at 120° C. for 2 h, and then decreased to 60° C. over 3 h. Then an optical resin material was obtained, after coating, the obtained optical lens was placed at 50° C. and 95% RH for 200 h, and performance test was carried out after accelerated aging verification.

### Comparative Embodiment 1

### An Optical Resin Material

(1) Polythiol composition: 5.3 g of tris (3-mercaptopropionate)pentaerythritol, 0.3 g of disulfide substitute, 40 g of tetrakis(3-mercaptopropionate)pentaerythritol, 4.5 g of [2,2-bis(3-sulfonylpropionyloxymethyl)-3-[3-(3-sulfonylpropionylsulfonyl)propionyloxy]propyl]3-sulfonylpropionate, 51.9 g of 2,3-dithio(2-mercapto)-1-propanethiol;
(2) 55 parts of norbornane diisocyanate, 45 parts of polythiol composition, 0.05 part of dibutyltin dichloride, 0.6 part of UV absorber 329, and 0.1 part of mold release agent (dibutyl phosphate) were evenly mixed, filtered by a 1 um filter, and degassed in vacuum at 30° C. for 30 min, and injected into a mold, when injecting the mold, the gun head was blocked by gel, and pouring cannot be carried out.

### Comparative Embodiment 2

### An Optical Resin Material

(1) Polythiol composition: 5.3 g of tris (3-mercaptopropionate)pentaerythritol, 40 g of tetrakis(3-mercaptopropionate)pentaerythritol, 4.5 g of [2,2-bis(3-sulfonylpropionyloxymethyl)-3-[3-(3-sulfonylpropionylsulfonyl)propionyloxy]propyl]3-sulfonylpropionate, 51.9 g of 2,3-dithio(2-mercapto)-1-propanethiol;
(2) 55 parts of norbornane diisocyanate, 45 parts of polythiol composition, 0.05 part of dibutyltin dichloride, 0.6 part of UV absorber 329, and 0.1 part of mold release agent (dibutyl phosphate) were evenly mixed, filtered by a 1 μm filter, and degassed in vacuum at 30° C. for 30 min, and injected into a mold. The temperature was increased from 30° C. to 120° C. in a gradient manner over 8 h, kept at 120° C. for 2 h, and then decreased to 60° C. over 3 h. Then an optical resin material was obtained, after coating, the obtained optical lens was placed at 50° C. and 95% RH for 200 h, and performance test was carried out after accelerated aging verification.

### Comparative Embodiment 3

### An Optical Resin Material

(1) Polythiol composition: 5.3 g of tris (3-mercaptopropionate)pentaerythritol, 40 g of tetrakis(3-mercaptopropionate)pentaerythritol, 4.5 of [2,2-bis(3-sulfonylpropionyloxymethyl)-3-[3-(3-sulfonylpropionylsulfonyl)propionyloxy] propyl]3-sulfonylpropionate, 51.9 g of 2,3-dithio(2-mercapto)-1-propanethiol;
(2) 55 parts of norbornane diisocyanate, 45 parts of polythiol composition, 0.1 part of dibutyltin dichloride, 0.6 part of UV absorber 329, and 0.1 part of mold release agent (dibutyl phosphate) were evenly mixed, filtered by a 1 μm filter, and degassed in vacuum at 30° C. for 30 min, and injected into a mold. The temperature was increased from 30° C. to 120° C. in a gradient manner over 8 h, kept at 120° C. for 2 h, and then decreased to 60° C. over 3 h. Then an optical resin material was obtained, after coating, the obtained optical lens was placed at 50° C. and 95% RH for 200 h, and performance test was carried out after accelerated aging verification.

### Test Embodiments

TABLE 1
Performance Test Data

| | | | | | | | Aging at 50° C. and | | | |
|---|---|---|---|---|---|---|---|---|---|---|
| | | Water | Before aging | | | | 95% RH for 200 h | | | |
| | | vapor | Front | | Edge | | Front | | Edge | |
| | | trans- | | Light | | Light | | Light | | Light |
| | | mittance | YI | trans- | YI | trans- | YI | trans- | YI | trans- |
| Embodiments | Ratio | g/(m²-day) | 313 | mittance % | 313 | mittance % | 313 | mittance % | 313 | mittance % |
| Embodiment 2 | 0.0005 | 0.43 | 1.27 | 98.8 | 1.17 | 98.9 | 2.74 | 94.9 | 5.31 | 87.7 |
| Embodiment 3 | 0.0024 | 0.33 | 1.18 | 98.9 | 1.17 | 98.9 | 2.42 | 95.3 | 4.17 | 88.5 |
| Embodiment 4 | 0.0038 | 0.15 | 0.97 | 98.3 | 1 | 98.3 | 2.16 | 95.7 | 4.56 | 89.3 |
| Embodiment 5 | 0.0054 | 0.11 | 1.23 | 98.6 | 1.22 | 98.6 | 2.03 | 95.8 | 4.42 | 89.6 |
| Embodiment 6 | 0.0038 | 0.14 | 1.00 | 98.5 | 1.03 | 98.4 | 2.18 | 95.9 | 4.55 | 89.5 |
| Comparative | 0.0075 | When the mold was poured, the gun head was blocked by gel and cannot be poured | | | | | | | | |
| Embodiment 1 | | | | | | | | | | |
| Comparative | 0 | 0.62 | 1.34 | 98.2 | 1.33 | 98.2 | 3.42 | 94.1 | 7.09 | 85.4 |
| Embodiment 2 | | | | | | | | | | |
| Comparative | 0 | 0.94 | 1.19 | 98.5 | 1.21 | 98.5 | 3.57 | 93.6 | 8.15 | 83.2 |
| Embodiment 3 | | | | | | | | | | |

The ratio in Table 1 above is the mass ratio of the tetrakis(3-mercaptopropionate)pentaerythritol disulfide substitute to the tetrakis(3-mercaptopropionate)pentaerythritol.

According to the above data in Table 1, because the content of tetrakis(3-mercaptopropionate)pentaerythritol disulfide substitute in Comparative Embodiment 1 is too large, resulting in high viscosity, and when the mold was poured, the gun head was blocked by gel, so that the casting cannot be carried out; after aging, the front light transmittance of the products in the embodiments 2-4 of the present application is higher than that of the products in the comparative embodiments 2-3, and the yellow value thereof is far lower than that of the products in comparative embodiments. Moreover, the light transmittance of the edge of the products in the embodiments 2-4 is higher than that of the products in comparative embodiments 2-3, and the yellow value thereof is far lower than that of the products in comparative embodiments 2-3. Through the verification of the test embodiments, it is further proved that the tetrakis(3-mercaptopropionate)pentaerythritol disulfide substitute in the specific proportion in the polythiol composition can effectively avoid the phenomenon of gel polymerization inhibition, and presence of active groups in resin lenses and the permeation of water and oxygen are reduced, thereby greatly reducing the aging and yellowing process of the resin lenses, reducing the occurrence of prism effect and reducing visual fatigue and prolonging the service life of glasses.

What is claimed is:

1. An optical resin material, characterized in that a raw material of the optical resin material comprises a polythiol composition and an isocyanate; the polythiol composition comprising tetrakis(3-mercaptopropionate)pentaerythritol and a tetrakis(3-mercaptopropionate)pentaerythritol disulfide substitute, and a structural formula of the tetrakis(3-mercaptopropionate)pentaerythritol disulfide substitute is shown as Formula 1: 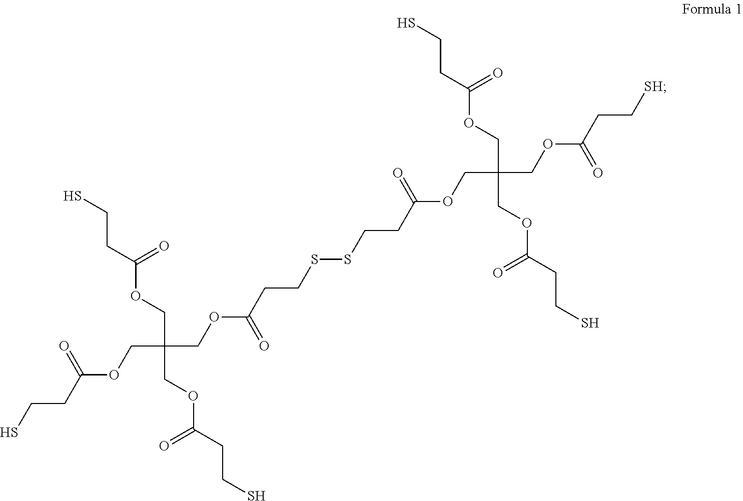 [SMILES: O=C(CCS)OCC(COC(=O)CCS)(COC(=O)CCS)COC(=O)CCSSCCC(=O)OCC(COC(=O)CCS)(COC(=O)CCS)COC(=O)CCS]
a mass ratio of the tetrakis(3-mercaptopropionate)pentaerythritol disulfide substitute to the tetrakis(3-mercaptopropionate)pentaerythritol is 1:181-10000.

2. The optical resin material according to claim 1, characterized in that the polythiol composition comprises 50-90 parts of the tetrakis(3-mercaptopropionate)pentaerythritol and the tetrakis(3-mercaptopropionate)pentaerythritol disulfide substitute, 10-20 parts of tris(3-mercaptopropionate)pentaerythritol, 2-15 parts of [2,2-bis(3-sulfonylpropionyloxymethyl)-3-[3-(3-sulfonylpropionylsulfonyl)propionyloxy]propyl]3-sulfonylpropionate, and 50-145 parts of 2,3-dithio(2-mercapto)-1-propanethiol.

3. The optical resin material according to claim 2, characterized in that the polythiol composition also comprises 1-5 parts of bis(3-mercaptopropionate)pentaerythritol, 0-3 parts of 3-mercaptopropionate pentaerythritol, 0-5 parts of [2-(hydroxymethyl)-2-(3-sulfonylpropionyloxymethyl)-3-[3-(3-sulfonylpropionylsulfonyl)propionyloxy]propyl]3-sulfonylpropionate.

4. The optical resin material according to claim 1, characterized in that the isocyanate is selected from one or more of m-xylylene diisocyanate, cyclohexane dimethylene diisocyanate, hexamethylene diisocyanate, isophorone diisocyanate and norbornane diisocyanate in any proportion.

5. The optical resin material according to claim 1, characterized in that the optical resin material is obtained by curing the raw material.
